(19) United States
(12) Patent Application Publication
(10) Pub. No.: US 2015/0319662 A1
(43) Pub. Date: Nov. 5, 2015

(54) MOBILE COMMUNICATION SYSTEM AND UE

(71) Applicant: SHARP KABUSHIKI KAISHA, Osaka-shi, Osaka (JP)

(72) Inventors: Masayuki ENOMOTO, Osaka-shi (JP); Masafumi ARAMOTO, Osaka-shi (JP)

(73) Assignee: SHARP KABUSHIKI KAISHA, Osaka-shi, Osaka (JP)

(21) Appl. No.: 14/762,045

(22) PCT Filed: Jan. 21, 2014
(86) PCT No.: PCT/JP2014/051072

§ 371 Date: Jul. 20, 2015

(30) Foreign Application Priority Data
Jan. 21, 2013 (JP) 2013-008183

(51) Int. Cl. H04W 36/14; H04L 12/24; H04W 88/06; H04W 24/04; H04W 48/18; H04W 88/16

(52) U.S. Cl. CPC H04W 36/14; H04W 48/18; H04W 88/16; H04W 88/06; H04W 24/04; H04L 41/5045

(57) ABSTRACT

A policy management device transmits an update of a mobile operator policy that requests to switch an access system for each flow that UE is going to perform communication. In addition, the policy management device requests to enable a network interface that is to be used for performing communication by making a connection to the switched access system. The UE compares the received update of the mobile operator policy with a UE policy that is held in advance and determines which is to be preferentially used. In a case where the UE determines to preferentially use the mobile operator policy, the UE switches the access system to offload communication.

### TECHNICAL FIELD

The present invention relates to a mobile communication system or the like including a packet data network gateway (PGW), user equipment (UE) that establishes a communication path utilizing a first access system to the PGW and a communication path utilizing a second access system to the PGW, and a policy management device that notifies the UE of a mobile operator policy.

This application claims priority from Japanese Patent Application No. 2013-8183 filed in Japan on Jan. 21, 2013, the entire contents of which are hereby incorporated by reference.

### BACKGROUND ART

The 3rd Generation Partnership Project (3GPP), which is a standards group for mobile communication systems, is proceeding with a work of specifying the Evolved Packet System (EPS) described in the following NPL 1 as a next-generation mobile communication system, and considering use of not only Long Term Evolution (LTE) but also Wireless LAN (WLAN) and Worldwide Interoperability for Microwave Access (WiMAX) as access systems connected to the EPS.

Further, the 3GPP is considering the recent surge in traffic caused by accesses from smartphones to the Internet. Under the assumption that the traffic will become too much for LTE alone, the 3GPP is considering a system in which LTE is switched to another access system such as a wireless LAN or WiMAX in accordance with a situation to offload traffic, so as to avoid concentration of traffic in LTE.

According to NPL 1, IP Flow Mobility (IFOM) has been considered and specified as a technique for avoiding concentration of traffic by utilizing a plurality of access systems. IFOM is a technique for assigning access systems to individual flows so that traffic can be distributed. Here, a flow is a group of pieces of communication data having a common characteristic. The characteristic of communication data can be identified by, for example, a transmission-source IP address, a transmission-destination IP address, a transmission-source port number, a transmission-destination IP address, a protocol number (these five parameters are referred to as IP5), and so forth.

NPL 2 describes a method in which user equipment (UE) serving as a mobile communication terminal utilizes an access network discovery and selection function (ANDSF) in a procedure of switching an access system. The ANDSF is a policy management device having a function of selecting an access system for each of one or a plurality of flows that the UE is communicating or the UE is going to communicate, and notifying the UE of the selected access system as a policy of a mobile operator (MO).

The UE holds a policy in which an access system to be utilized is associated with each of one or a plurality of flows that the UE is communicating or the UE is going to communicate. In response to a notification indicating an access system from the ANDSF, the notification being given as an update of an MO policy, the UE determines whether to apply the access system included in the update of the MO policy. In the case of applying the MO policy, the UE reflects it in the UE policy, and then switches the access system to be utilized for transmitting/receiving a flow on the bass of the UE policy.

Here, the UE policy is set by a user in accordance with a billing status, and indicates whether the UE is connectable to a plurality of access systems. The UE policy is a policy related to selection of a communication path by the UE, for example, in a case where the cost is lower in the case of utilizing a communication path via an access network including WLAN than in the case of utilizing a communication path via an access network including LTE, the communication path via the access network including WLAN is preferentially utilized.

Thus, the UE does not necessarily need to comply with an update of the MO policy indicated by the notification from the ANDSF. In the case of not applying the update of the MO policy, the UE does not need to change the UE policy, and in this case does not need to switch the access system. Such an application is determined by a UE setting or a setting based on the intention of the user who owns the UE.

### CITATION LIST

### Non Patent Literature

NPL 1: 3GPP TS 23.261 Technical Specification Group Services and System Aspects, IP flow mobility and seamless Wireless Local Area Network (WLAN) offload, Stage 2 (Release 10)

NPL 2: 3GPP TS 23.402 General Technical Specification Group Services and System Aspects, Architecture enhancements for non-3GPP accesses

### SUMMARY OF INVENTION

### Technical Problem

IFOM has enabled the UE to switch an access system for each flow. However, although the MO has means for notifying the UE of a policy of the MO, the UE does not necessarily need to select an access system to be utilized in communication of a flow in accordance with an update of the MO policy.

Accordingly, a problem remains in which the MO is not always able to alleviate concentration of traffic in LTE only by notifying the UE of an update of the MO policy. In a case where the MO monitors the traffic in a communication system and generates an MO policy for optimizing data transmission in the entire communication system, even if the MO generates an MO policy for reducing traffic in LTE and increasing traffic in WLAN and notifies the UE of the MO policy, for example, the UE does not necessarily switch an access system on the basis of an update of the MO policy, and thus data transmission is not optimized.

In a case where the UE rarely exists in an area where WLAN is available because the area where access via WLAN is available is small, continuous search for an access point of WLAN may result in quick consumption of a battery.

The user who owns the UE does not like such battery consumption, and tends to disable the function of connecting to WLAN in a case where the user is not sure whether connection to WLAN can be reliably established.

The mobile operator does not have means for enabling the WLAN function for the UE that has disabled the WLAN function, and is not able to cause the UE to perform offload.

The present invention has been made in view of these circumstances, and provides a mobile communication system or the like capable of performing offload to distribute traffic in accordance with the intention of a mobile operator. More specifically, for UE (mobile station device) that is performing data communication through connection to a first access system (for example, LTE base station device), the necessity for offloading data by the UE is detected in accordance with a status of an access system or core network, and a mobile operator policy to be used by the UE to perform offload is generated. Further, the mobile operator notifies the UE of an update of the mobile operator policy (MO policy) by using an ANDSF, and thereby requests the UE to enable a WLAN function and perform offload according to the update of the MO policy. Accordingly, the UE changes a UE policy in accordance with the update of the MO policy, so that the intention of the MO can be appropriately reflected and concentration of traffic in the first access system (for example, LTE base station device) can be avoided.

### Solution to Problem

In view of the above-described problem, a mobile communication system according to an aspect of the present invention is a mobile communication system that includes a packet data network gateway (PGW), user equipment (UE), and a policy management device. The UE establishes a communication path utilizing a first access system to the PGW and a communication path utilizing a second access system to the PGW. The UE includes a first network interface that performs communication through the communication path utilizing the first access system and a second network interface that is different from the first network interface and that performs communication through the communication path utilizing the second access system. The UE performs communication of a plurality of flows. The policy management device notifies the UE of a mobile operator policy. The UE has a UE policy in which flow identification information is associated with access system identification information so as to select an access system for each flow, and performs communication of a flow by using the communication path utilizing the first access system on the basis of the UE policy. The policy management device includes update means for updating the mobile operator policy in which flow identification information on flows communicated by the UE is associated with access system identification information and policy transmitting means for transmitting the mobile operator policy and a request for enabling a network interface to the UE. The UE includes policy receiving means for receiving the mobile operator policy and the request for enabling the network interface, determining means for detecting that an access system information item corresponding to a flow identified by the flow identification information in the UE policy is different from an access system information item corresponding to a flow identified by the flow identification information in the mobile operator policy, communication path establishing means for, in a case where the determining means determines that both the access system information items are different from each other, enabling the network interface on the basis of the request for enabling the network interface and establishing the communication path utilizing the second access system, and communication path switching means for switching communication of the flow identified by the flow identification information to the communication path utilizing the second access system.

Further, user equipment (UE) according to an aspect of the present invention is UE in a mobile communication system that includes a packet data network gateway (PGW), the UE, and a policy management device. The UE establishes a communication path utilizing a first access system to the PGW and a communication path utilizing a second access system to the PGW. The UE includes a first network interface that performs communication through the communication path utilizing the first access system and a second network interface that is different from the first network interface and that performs communication through the communication path utilizing the second access system. The UE performs communication of a plurality of flows. The policy management device notifies the UE of a mobile operator policy. The UE has a UE policy in which flow identification information is associated with access system identification information so as to select an access system for each flow. The UE includes communication means for performing communication of a flow by using the communication path utilizing the first access system on the basis of the UE policy, policy receiving means for receiving the mobile operator policy that includes flow identification information and access system identification information and a request for enabling a network interface, determining means for detecting that an access system information item corresponding to a flow identified by the flow identification information in the UE policy is different from an access system information item corresponding to a flow identified by the flow identification information in the mobile operator policy, communication path establishing means for, in a case where the determining means determines that both the access system information items are different from each other, enabling the network interface on the basis of the request for enabling the network interface and establishing the communication path utilizing the second access system, and communication path switching means for switching communication of the flow identified by the flow identification information to the communication path utilizing the second access system.

Further, the UE according to an aspect of the present invention may further include communication path establishing means for establishing the communication path utilizing the first access system by using an APN identifier, and communication path switching request means for, in a case of enabling the network interface on the basis of the request for enabling the network interface and establishing the communication path utilizing the second access system, requesting switching of a communication path for transmitting, to the PGW, a request for switching communication of the flow identified by the flow identification information to the communication path utilizing the second access system by including the APN identifier in the request. The UE may request to continuously use an IP address that is obtained when the communication path utilizing the first access system is established.

Further, the UE according to an aspect of the present invention may establish the communication path utilizing the first access system by using an APN identifier, and may further include communication path switching request means for, in a case of enabling the network interface on the basis of the request for enabling the network interface and establishing the communication path utilizing the second access system, making a request to switch communication of the flow identified by the flow identification information to the communication path utilizing the second access system by including an APN identifier different from the APN identifier in the request. The UE may requests to perform communication by switching an IP address to an IP address different from an IP address that is obtained when the communication path utilizing the first access system is established.

Further, the UE according to an aspect of the present invention may receive an APN identifier in addition to the mobile operator policy including flow identification information and access system identification information and a request for enabling a network interface, and may request to establish the communication path utilizing the second access system by using the APN identifier.

### Advantageous Effects of Invention

According to an aspect of the present invention, a mobile operator (MO) causes UE that has disabled a WLAN function to enable the WLAN function and to switch an access system in accordance with an update of an MO policy, so that offload for appropriately alleviating concentration of traffic in LTE can be implemented.

### BRIEF DESCRIPTION OF DRAWINGS

FIG. 1 is a diagram for describing an overview of a mobile communication system 1 according to an embodiment.

FIG. 2 is a diagram for describing a functional configuration of UE according to a first embodiment.

FIG. 3A is a first diagram illustrating an example of a data structure of a UE policy according to the first embodiment.

FIG. 3B is a second diagram illustrating an example of the data structure of the UE policy according to the first embodiment.

FIG. 4 is a diagram for describing a functional configuration of an ANDSF according to the first embodiment.

FIG. 5 is a diagram for describing a functional configuration of an MO policy according to the first embodiment.

FIG. 6A is a first diagram for describing a configuration of an IP mobile communication network.

FIG. 6B is a second diagram for describing the configuration of the IP mobile communication network.

FIG. 7 is a diagram for describing a processing flow of the UE and ANDSF.

FIG. 8 is a diagram illustrating an example of access system information according to the first embodiment (first example).

FIG. 9 is a diagram illustrating an example of an update of the MO policy according to the fist embodiment (first example).

FIG. 10 is a diagram for describing switching of an access system according to the first embodiment (first example).

FIG. 11 is a diagram for describing switching of an access system according to the first embodiment (second example).

FIG. 12 is a diagram for describing switching of an access system according to the first embodiment (third example).

FIG. 13 is a diagram for describing switching of an access system according to the first embodiment (fourth example).

### DESCRIPTION OF EMBODIMENTS

Hereinafter, the best embodiment for carrying out the present invention will be described with reference to the drawings. In this embodiment, an embodiment of a mobile communication system in a case where the present invention is applied will be described in detail as an example by using the drawings.

### 1. First Embodiment

First, a first embodiment to which the present invention is applied will be described with reference to the drawings.

### 1.1 Overview of Mobile Communication System

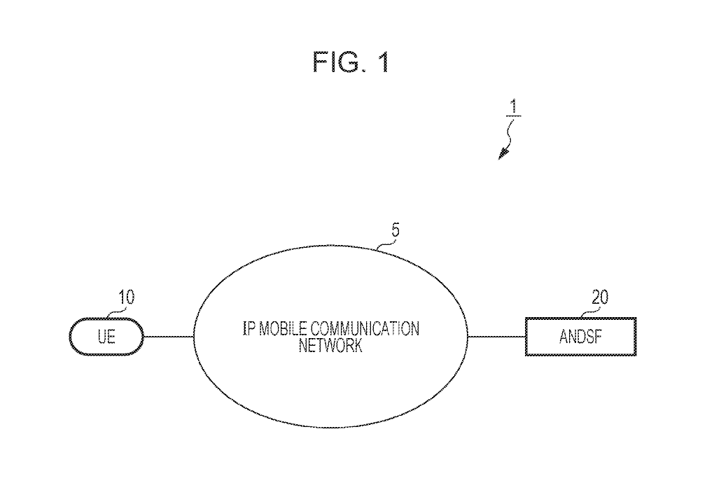

FIG. 1 is a diagram for describing an overview of a mobile communication system 1 according to this embodiment. As illustrated in FIG. 1, the mobile communication system 1 includes UE (a mobile station device) 10 and an access network discovery and selection function (a policy management device for selecting a communication path) 20 (ANDSF), which are connected to each other via an IP mobile communication network 5.

The IP mobile communication network 5 may be, for example, a network made up of a radio access network operated by a mobile communication carrier and a core network, or may be a broadband network operated by a fixed communication carrier. An IP mobile communication network operated by a mobile communication carrier will be described in detail below.

The broadband network is an IP communication network operated by a communication carrier, in which a connection is made through Asymmetric Digital Subscriber Line (ADSL) or the like and high-speed communication utilizing a digital line such as an optical fiber is provided. The broadband network is not limited thereto, and may be a network in which a radio access is made by using Worldwide Interoperability for Microwave Access (WiMAX) or the like.

The UE 10 is a communication terminal that makes a connection by using an access system such as LTE or WLAN, and is able to connect to an IP access network by using a communication interface for 3GPP LTE, a communication interface for WLAN, or the like loaded therein to make the connection.

Specific examples of the UE 10 include a mobile phone terminal and a smartphone, and a tablet computer, personal computer, and home appliance having a communication function.

The ANDSF 20 is connected to the IP access network by using a wired line or the like. The wired line is constructed by, for example, Asymmetric Digital Subscriber Line (ADSL), an optical fiber, or the like. Alternatively, the connection may be made via a radio access network such as Long Term Evolution (LTE), Wireless LAN (WLAN), Worldwide Interoperability for Microwave Access (WiMAX), or the like.

### 1.2 Device Configuration

Next, the configurations of the individual devices will be briefly described by using the drawings.

### 1.2.1 Configuration of UE

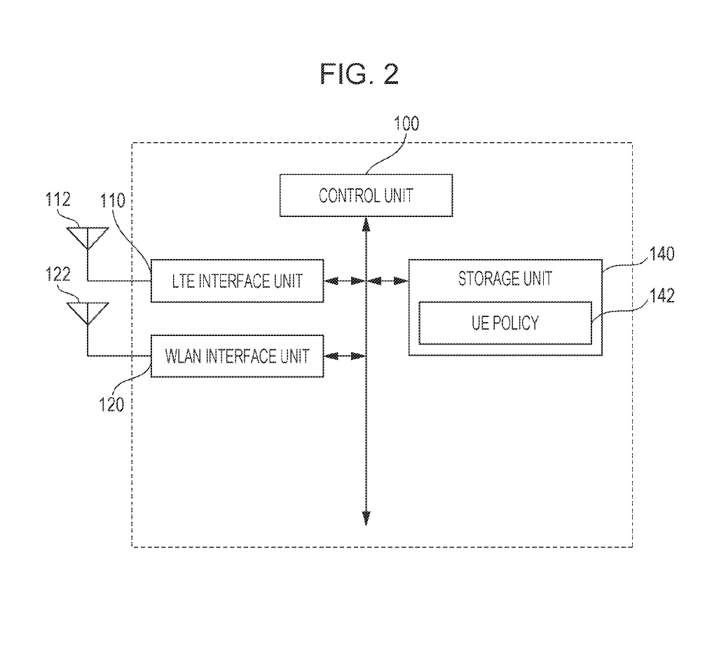

FIG. 2 illustrates the functional configuration of the UE 10 according to this embodiment. In the UE 10, an LTE interface unit 110, a WLAN interface unit 120, and a storage unit 140 are connected to a control unit 100 via a bus.

The control unit 100 is a functional unit for controlling the UE 10. The control unit 100 reads and executes various programs stored in the storage unit 140, and thereby implements various processing operations.

The LTE interface unit 110 is a functional unit that is used by the UE 10 to connect to an LTE base station and connect to the IP access network. An external antenna 112 is connected to the LTE interface unit 110.

The WLAN interface unit 120 is a functional unit that is used by the UE 10 to connect to a WLAN access point and connect to the IP access network. An external antenna 122 is connected to the WLAN interface unit 120.

The storage unit 140 is a functional unit for storing programs, data, and so forth that are necessary for various operations of the UE 10. The storage unit 140 is made up of, for example, a semiconductor memory, a hard disk drive (HDD), or the like. Further, the storage unit 140 stores a UE policy 142.

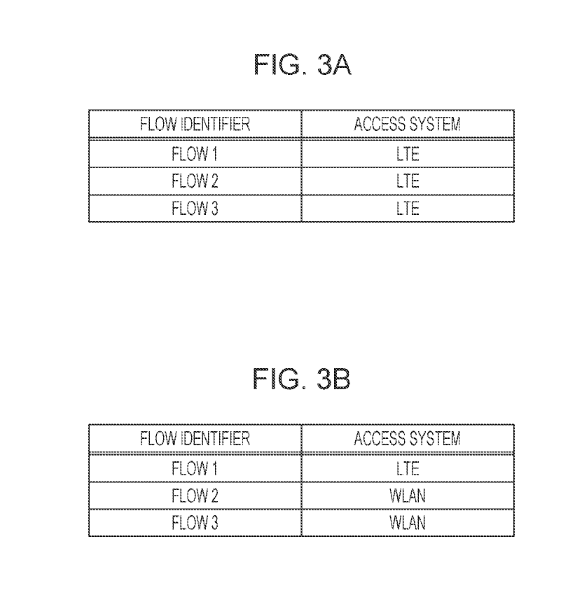

FIG. 3A and FIG. 3B are diagrams each illustrating an example of the UE policy 142. For example, as illustrated in FIG. 3A, flow identifiers (for example, “flow 1”) and access systems (for example, “LTE”) are stored in association with each other, and access systems to be applied by the UE 10 for individual flows are managed.

Here, a flow is a flow of data that is identifiable by a transmission-source IP address, a transmission-destination IP address, a transmission-source port number, a transmission-destination port number, a protocol number, or the like. The flow is not limited thereto, and may be a flow of various data that is transmitted/received, such as data transmitted/received over a certain period from a certain time, or data that is identifiable in a Qos level. An access system is not necessarily LTE, and may be WLAN or WiMAX.

The UE 10 is able to manage access systems to be connected for individual flows by using the UE policy 142. In the case of making a connection via the same access system for all flows, the UE 10 may perform management by making a connection to the same access system for each flow, or may manage access systems by using an identifier “ALL” or the like for identifying “all flows” as a flow identifier.

### 1.2.2 Configuration of ANDSF

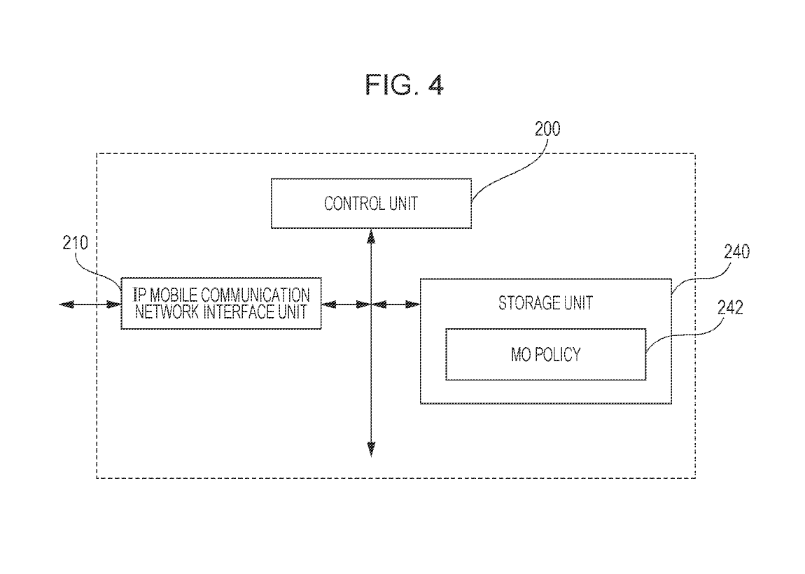

Next, the functional configuration of the ANDSF 20 according to this embodiment is illustrated in FIG. 4. In the ANDSF 20, an IP mobile communication network interface unit 210 and a storage unit 240 are connected to a control unit 200 via a bus.

The control unit 200 is a functional unit for controlling the ANDSF 20. The control unit 200 reads and executes various programs stored in the storage unit 240, and thereby implements various processing operations.

The IP mobile communication network interface unit 210 is a functional unit that is used by the ANDSF 20 to connect to the IP mobile communication network.

The storage unit 240 is a functional unit for storing programs, data, and so forth that are necessary for various operations of the ANDSF 20. The storage unit 240 is made up of, for example, a semiconductor memory, a hard disk drive (HDD), or the like. Further, the storage unit 240 stores an MO policy 242.

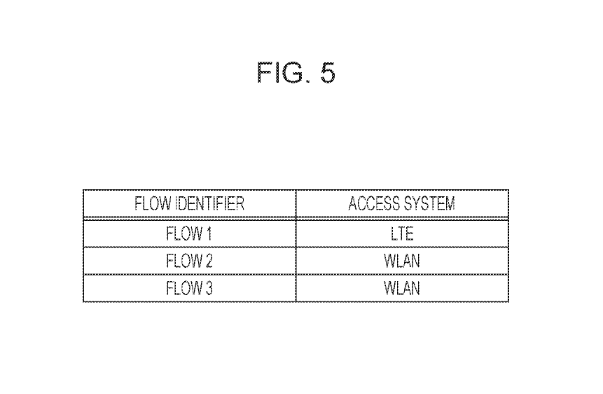

FIG. 5 is a diagram illustrating an example of the MO policy 242. For example, as illustrated in FIG. 5, the ANDSF 20 stores flow identifiers (for example, “flow 1”) and access systems (for example, “LTE”) in association with each other, and manages access systems to be applied for individual flows reported to the UE 10 by the ANDSF 20.

A mobile operator performs, for each flow communicated by the UE 10, management by associating an access system to be used for communication of the flow by using the MO policy 242. That is, the mobile operator manages the necessity/unnecessity of offload for each flow communicated by the UE 10. For example, the mobile operator performs control to update the access system for the flow identified by flow 1 in the MO policy 242 from LTE to WLAN, so as to offload communication of flow 1 from LTE to WLAN.

The mobile operator is able to determine an update of the MO policy 242 in accordance with the traffic status of the IP mobile communication network 5. For example, the mobile operator is able to perform offload for the purpose of distributing load in accordance with the load status of the devices included in the IP mobile communication network 5, such as a base station device and a gateway device.

Also, the mobile operator is able to offload a specific flow on the basis of information on a flow identified by the type of flow, such as motion video distribution, or on a flow identified by connection destination information of the flow, such as a domain of a connection destination.

### 1.2.3 Example Configuration of IP Mobile Communication Network

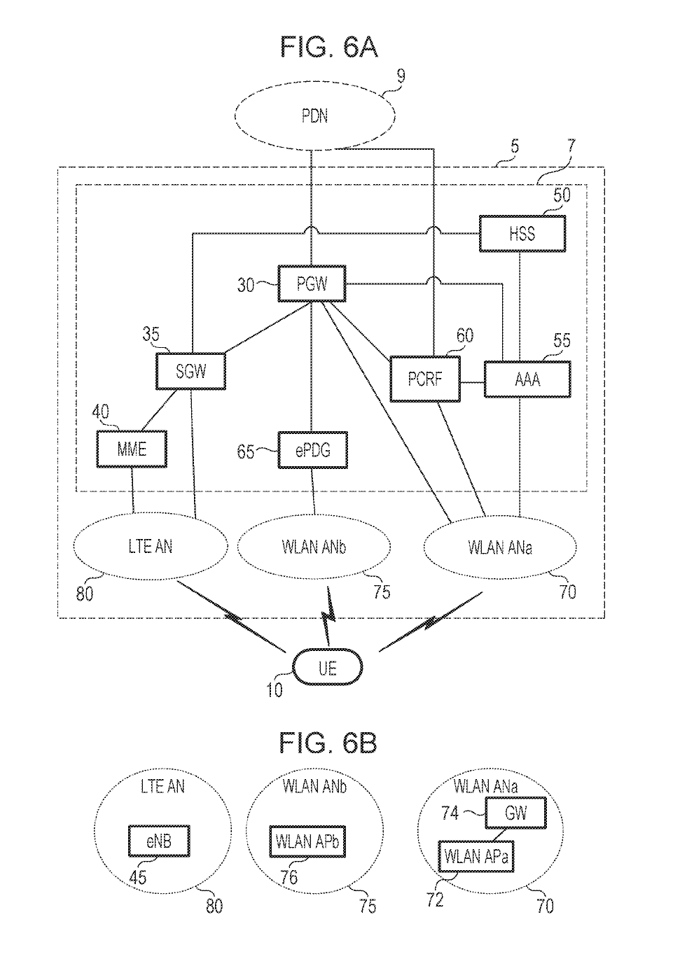

As illustrated in FIG. 6A and FIG. 6B, the mobile communication system is made up of the UE 10, the IP mobile communication network 5, and a packet data network (PDN) 9. Further, the IP mobile communication network 5 is made up of a core network 7 and individual radio access networks. A detailed configuration of the core network is illustrated in FIG. 6A.

The PDN 9 is a network that provides a network service in which data is transmitted and received by using packets, and is, for example, the Internet or IMS.

The core network 7 includes a packet data network gateway (PGW) 30 (an access control device), a serving gateway (SGW) 35, a mobile management entity (MME) 40, a home subscriber server (HSS) 50, an authentication, authorization, accounting (AAA) 55, a policy and charging rules function (PCRF) 60, and an enhanced packet data gateway (ePDG) 65.

A radio access network may be made up of a plurality of different access networks. The individual access networks are connected to the core network 7. Further, the UE 10 is able to wirelessly connect to a radio access network.

The radio access network may be an LTE access network (LTE AN 80) connectable by using an LTE access system, and an access network connectable by using a WLAN access system.

Further, the access network connectable by using the WLAN access system may be a WLAN access network b (WLAN ANb 75) to which a connection is made by using the ePDG 65 as a connection device for the core network, and a WLAN access network a (WLAN ANa 70) connected to the PGW 30, the PCRF 60, and the AAA 55.

The individual devices have similar configurations to conventional devices in a mobile communication system utilizing EPS, and thus the detailed description thereof is omitted. A brief description of the functions is as follows. The PGW 30 is connected to the PDN 9, the SGW 35, the ePDG 65, the WLAN ANa, the PCRF 60, and the AAA 55, and serves as a gateway device for the PDN 9 and the core network 7 to transmit user data.

The SGW 35 is connected to the PGW 30, the MME 40, and the LTE AN 80, and serves as a gateway device for the core network 7 and the LTE AN 80 to transmit user data.

The MME 40 is connected to the SGW 35 and the LTE AN 80, and serves as an access control device for performing access control of the UE 10 via the LTE AN 80.

The HSS 50 is connected to the SGW 35 and the AAA 55 and manages subscriber information. The AAA 55 is connected to the PGW 30, the HSS 50, the PCRF 60, and the WLAN ANa 70, and performs access control of the UE 10 connected via the WLAN ANa 70. The PCRF 60 is connected to the PGW 30, the WLAN ANa 70, and the AAA 55, and performs QoS management for data transmission.

The ePDG 65 is connected to the PGW 30 and the WLAN ANb 75, and serves as a gateway device for the core network 7 and the WLAN ANb 75 to transmit user data.

As illustrated in FIG. 6B, each radio access network includes a device or the like to which the UE 10 is actually connected (for example, a base station device or an access point device). Various devices adapted to a radio access network may be available as a device used for connection. In this embodiment, the LTE AN 80 includes an eNB 45. The eNB 45 is a radio base station to which the UE 10 is connected by using an LTE access system. The LTE AN 80 may include one or a plurality of radio base stations.

Further, the WLAN ANa 70 includes a WLAN APa 72 and a gateway (GW) 74. The WLAN AP 72 is a radio base station to which the UE 10 is connected by using a WLAN access system. The WLAN AN 70 may include one or a plurality of radio base stations. The GW 74 is a gateway device for the core network 7 and the WLAN ANa 70. The WLAN APa 72 and the GW 74 may be made up of a single device.

In this way, the gateway included in the WLAN ANa 70 can be connected to a plurality of devices in the core network. In a case where a carrier that operates the core network is different from a carrier that operates the WLAN ANa 70, operation with such a configuration can be performed in a case where the carriers have a relationship of trust with each other based on a contract or rule about the operation. In other words, the WLAN APa 72 is an access network that is reliable for the carrier that operates the core network 7.

The WLAN ANb 75 includes a WLAN APb 76. The WLAN AP 76 is a radio base station to which the UE 10 is connected by using a WLAN access system. The WLAN AN 75 may include one or a plurality of radio base stations.

In this way, the WLAN ANb 75 is connected to the core network 7 by using the ePDG 65, which is a device included in the core network 7, as a gateway. The ePDG 65 has a security function for ensuring safety. In a case where the carrier that operates the core network is different from the carrier that operates the WLAN ANa 70, operation with such a configuration is performed in a case where the carriers do not have a relationship of trust with each other based on a contract or rule about the operation. In other words, the WLAN APa is an access network that is not reliable for the carrier that operates the core network 7, and provides safety in the ePDG 65 included in the core network 7.

In this description, a state where the UE 10 is connected to a radio access network corresponds to a state where the UE 10 is connected to a base station device, an access point, or the like included in the radio access network. The data and signals transmitted therefrom or received thereby are transmitted or received via the base station device or access point.

For example, a state where the UE 10 is connected to the LTE AN 80 corresponds to a state where the UE 10 is connected thereto via the eNB 45, and a state where the UE 10 is connected to the WLAN ANa 70 corresponds to a state where the UE 10 is connected thereto via the WLAN APa 72 and/or the GW 74. A state where the UE 10 is connected to the WLAN ANb 75 corresponds to a state where the UE 10 is connected to the WLAN APb 76.

### 1.3 Examples

### 1.3.1 First Example

Next, examples of specific processing in the above-described mobile communication system will be described. In a first example, in a state where the UE 10 is connected to the base station device (eNB 45) of the LTE AN 80, the UE 10 is performing communication of flow 1, flow 2, and flow 3 by using a communication path via LTE (via eNB 45, SGW 35, and PGW 30) in accordance with the UE policy before change illustrated in FIG. 3A. At this time, the UE 10 disables the WLAN function. If the WLAN function is enabled, the UE 10 performs processing of searching for a WLAN base station regardless of whether or not a connectable WLAN base station exists, and the processing consumes battery. If a connectable base station is found, the UE 10 is able to connect to the WLAN base station and establish a communication path via WLAN (via WLAN ANa 70 and PGW 30). However, according to the UE policy 242, there is no flow for which communication is performed via WLAN, and thus a communication path via WLAN is not used. That is, an unnecessary communication path is established.

To avoid such a situation, the UE 10 disables the WLAN function. Specifically, the UE 10 stops (disables) a network interface associated with WLAN. Accordingly, search for a WLAN base station and establishment of a connection or communication path via WLAN are not performed. Here, stopping of the network interface may be disabling of a network device.

A description will be given of a procedure of transmitting, in the above-described situation, from the ANDSF 20 to the UE 10, “WLAN” as an access system for flow 2 in the MO policy 242 illustrated in FIG. 5 so as to reflect the MO policy 242 in the UE policy 142, and performing switching from data transmission/reception using a communication path via the access system LTE (via eNB 45, SGW 35, and PGW 30) in flow 2 to data transmission/reception using a communication path via WLAN (via WLAN ANa 70 and PGW 30).

The individual communication paths are identifiable by access systems. The UE 10, the PGW 30, and the ANDSF 20 perform a procedure by using an access system as identification information on a communication path. In the UE policy 242, the information managed in association with flows may be managed as identification information on communication paths, not access systems. In this case, switching of a communication path for data transmission/reception can be performed by using identification information on communication paths, not identification information on access systems.

Hereinafter, a description will be given of an example in which a mobile operator selects an access system to be utilized by the UE 10 for communication of a flow and provide a notification by updating an MO policy.

In this embodiment, a description will be given of a procedure of performing switching from data transmission/reception via LTE (via eNB 45, SGW 35, and PGW 30) to data transmission/reception via WLAN (via WLAN ANa 70 and PGW 30). However, with WiMAX being transmitted as an access system in flow 2 as the MO policy 242 illustrated in FIG. 5 from the ANDSF 20 to the UE 10, switching from data transmission/reception via LTE (via eNB 45, SGW 35, and PGW 30) to data transmission/reception via WiMAX (for example, via WiMAX and PGW) can be performed in a similar procedure.

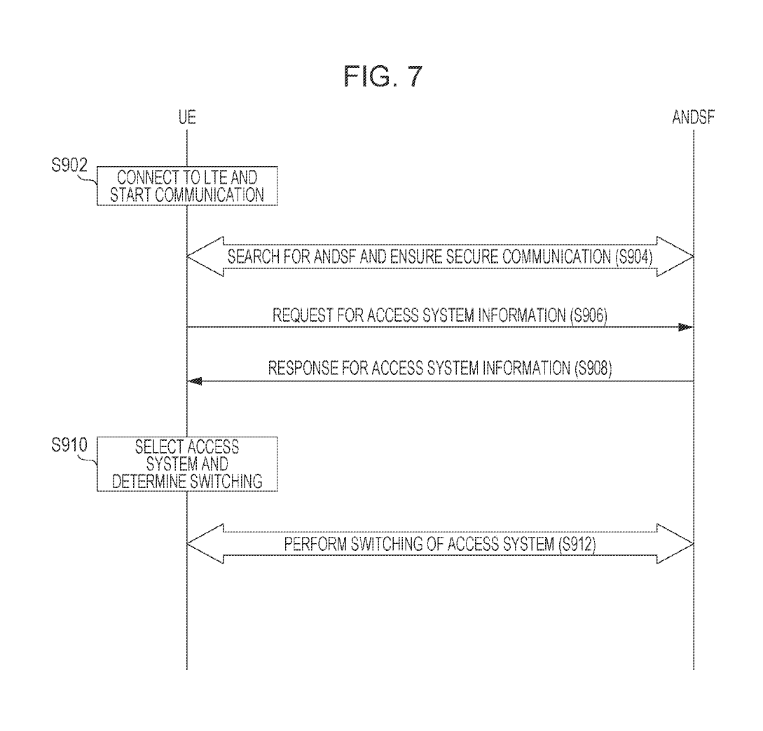

A description will be given in order by using FIG. 7. The UE 10 connects to the LTE AN 80 and starts communication (S902). For establishing the connection, the UE 10 performs an attachment procedure based on a 3GPP standard or the like for the communication network operated by the mobile operator, and establishes a communication path via LTE (via eNB 45, SGW 35, and PGW 30). After that, the UE 10 performs data transmission/reception for communication of flow 1, flow 2, and flow 3 by selecting the communication path via LTE (via eNB 45, SGW 35, and PGW 30) on the basis of the UE policy 242 illustrated in FIG. 3A.

Here, the UE policy 242 of the UE 10 may be preset by the manufacturer or mobile operator at the time of shipment of the terminal, or may be statistically set by a user setting.

Subsequently, the UE 10 searches for the ANDSF 20, and ensures secure communication with the found ANDSF 20 (S904).

Various methods for searching for the ANDSF 20 by the UE 10 are available. For example, the UE 10 may inquire of a DNS server provided in the PDN to search for the ANDSF 20. Also, various methods for ensuring secure communication between the UE 10 and the ANDSF 20 are available. For example, IPSec may be utilized.

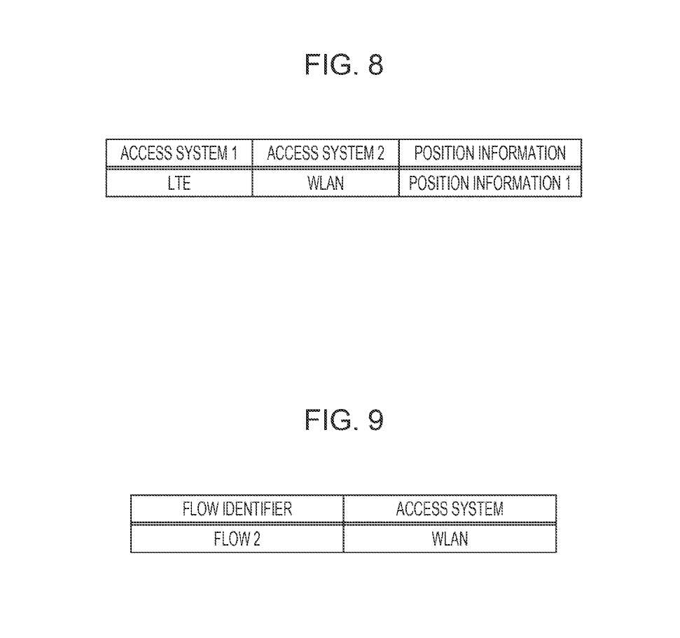

Subsequently, the UE 10 transmits a request for access system information to the ANDSF 20 (S906). At this time, as illustrated in FIG. 8, the request for access system information may include information on access systems that are available to the UE 10 and position information on the UE 10. Here, the access systems that are available to the UE 10 include access system 1 “LTE” and access system 2 “WLAN”. The position information includes position information 1, but is not limited thereto. The position information may include a cell ID of an LTE base station device, a tracking area ID (TAI), and information on a global positioning system (GPS).

The ANDSF 20 that has received the request for access system information from the UE 10 transmits a response for access system information to the UE 10 (S908). In accordance with the response for access system information, the MO notifies the UE 10 of an update of the MO policy. Specifically, as illustrated in FIG. 9, the update of the MO policy includes a flow identifier “flow 2” and an access system “WLAN”. Accordingly, the UE 10 receives the update of the MO policy of the mobile operator.

Further, the response for access system information may include information that is necessary for the UE 10 to connect to the access network of WLAN. The response may include, for example, information for connecting to WLAN, such as information on a WLAN base station to which the UE 10 is to be desirably connected, and an identifier such as an SSID that is necessary to make a connection. Further, these pieces of information may be determined on the basis of position information included in the request for access system information transmitted from the UE 10. Specifically, a connectable WLAN base station may be selected on the basis of position information obtained from a GPS, and a notification including information on the selected base station and an SSID to be used for making a connection to the base station may be provided to the UE 10.

Here, the ANDSF 20 holds in advance function information indicating that the UE 10 has a function of connecting to WLAN. The function information may indicate that the UE 10 has a communication function for connecting to WLAN. Alternatively, management may be performed by using authentication information indicating whether or not WLAN connection is permitted by the mobile operator in a state where the UE 10 has a communication function.

The function information may be managed by the mobile operator as subscriber information at the time when the user purchases the terminal, and may be held in the ANDSF 20.

Alternatively, the UE 10 may transmit, to the MME 40, an attachment request message together with function information in an attachment procedure that is performed to connect to the LTE AN 80, and the mobile operator may manage the function information received by the MME 40 in the ANDSF 20.

Alternatively, when the UE 10 ensures secure communication with respect to the ANDSF 20 (S0904), the UE 10 may transmit function information to the ANDSF 20, and thereby the mobile operator may manage the function information.

Alternatively, the UE 10 may transmit the request for access information (S906) together with function information to the ANDSF 20, and thereby the mobile operator may manage the function information.

With any of the above-described methods, the ANDSF 20 detects that the UE 10 has a function of connecting to WLAN.

The ANDSF 20 detects that the UE 10 has a function of connecting to WLAN and that a connection to the WLAN has not yet been established, and transmits a response for access system information to the UE 10 together with a flag that requests the UE 10 to enable the WLAN function.

The ANDSF 20 is able to detect that the UE 10 has not yet established a connection to WLAN by determining that the UE 10 has not yet established a communication path via WLAN (via WLAN ANa 70 and PGW 30) in the PGW 30.

Alternatively, more specifically, the ANDSF 20 is able to perform detection by determining that the UE 10 has not yet established a communication path via WLAN (via WLAN ANa 70 and PGW 30) on the basis of presence/absence of binding information based on a PMIP protocol that is managed by the PGW 30 when the UE 10 establishes a communication path via WLAN (via WLAN ANa 70 and PGW 30), or bearer information based on a GTP protocol.

In this way, the ANDSF 20 is able to detect that a connection to WLAN has not yet been established by receiving management information on the PGW 30 from the PGW 30.

Instead of the method for performing detection on the basis of the management information on the PGW 30, a method for performing detection by detecting whether or not a WLAN connection has been established in the MME 40 or the PCRF 60 and receiving information from the MME 40 or the PCRF 60.

In this embodiment, after the ANDSF 20 has received the request for access system information from the UE 10, the ANDSF 20 transmits the MO policy 242 as a response for the access system information to the UE 10. Alternatively, the ANDSF 20 may transmit the MP policy 242 to the UE 10 at a certain timing even if there is no request from the UE 10.

For example, the mobile operator updates the MO policy 242 in accordance with the traffic status of the IP mobile communication network 5, and transmits the MO policy 242 to the UE 10 in order to request offload in accordance with the update. For example, in a case where load increases due to surge of traffic in the LTE AN 80 or in a case where a heavy load of individual devices such as the eNB 45, SGW 35, PGW 30, and MME 40 is detected and it is determined that offload is necessary to distribute the load, the mobile operator is able to update the MO policy 242 and request the UE 10 to perform offload to WLAN in units of flows.

In the example of connecting the UE 10 to the ANDSF 20 illustrated in FIG. 7, a description has been given of an example in which the UE 10 ensures secure communication with the ANDSF 20 (S904) and immediately transmits a request for access system information. Alternatively, after secure communication has been ensured, the UE 10 may regularly transmit a request for access system information at a certain time interval, receive a response for access system information from the ANDSF 20, and determine whether or not the MO policy 242 has been updated.

In response to receipt of the response for access system information, the UE 10 selects an access system and determines switching of the access system to be utilized for a flow in accordance with the information included in the response for access system information (S910). Here, the response for access system information includes information on the access system “WLAN” for flow 2, and thus the UE 10 changes the access system LTE for flow 2 in the UE policy 142 before change illustrated in FIG. 3A to the access system WLAN for flow 2 in the UE policy 142, as in the UE policy after change illustrated in FIG. 3B. That is, the UE 10 changes the access system for flow 2 from LTE to WLAN, and determines switching of the access system.

Further, in response to the flag that requests enabling of the WLAN function, the UE 10 enables the WLAN function. Specifically, the UE 10 activates (enables) a network interface associated with WLAN. Accordingly, the UE 10 starts search for a WLAN base station and connection via WLAN. Here, activation of the network interface may be enabling of a network device.

Here, the UE 10 may determine not to perform switching on the basis of the UE policy 142. That is, in a case where the UE Policy 142 competes with the MO policy 242 that has been received as a response for access system information, the UE 10 may put a higher priority to the UE policy 142 and does not need to perform switching.

Here, the UE 10 that has received the response for access system information detects that the received update of the MO policy is different from the UE policy 142, and determines which of the update of the MO policy and the UE policy 142 is given a higher priority. In the determination, the UE 10 may determine not to perform switching for the purpose of avoiding power consumption resulting from enabling of the WLAN function, in accordance with residual battery information of the UE 10. Such a determination can be made by holding, in the UE 10, a threshold of a battery remaining level for determining not to enable the WLAN function or not to perform switching to WLAN, and comparing a current battery consumption status with the threshold.

Alternatively, the UE 10 may determine not to perform switching on the basis of a request from the user for continuing communication of a flow via LTE. Such a determination may be made by the UE 10 by requesting the user to input information, or management may be performed by associating information on a communication path to be used for a specific flow, for example, communication of flow 2 is performed via LTE.

On the other hand, in a case where it is determined that the remaining battery level is sufficiently high or in a case where the user has input a request for performing switching, the UE 10 performs switching of the access system in accordance with the update of the MO policy.

At this time, the UE policy 142 is updated in accordance with the received update of the MO policy.

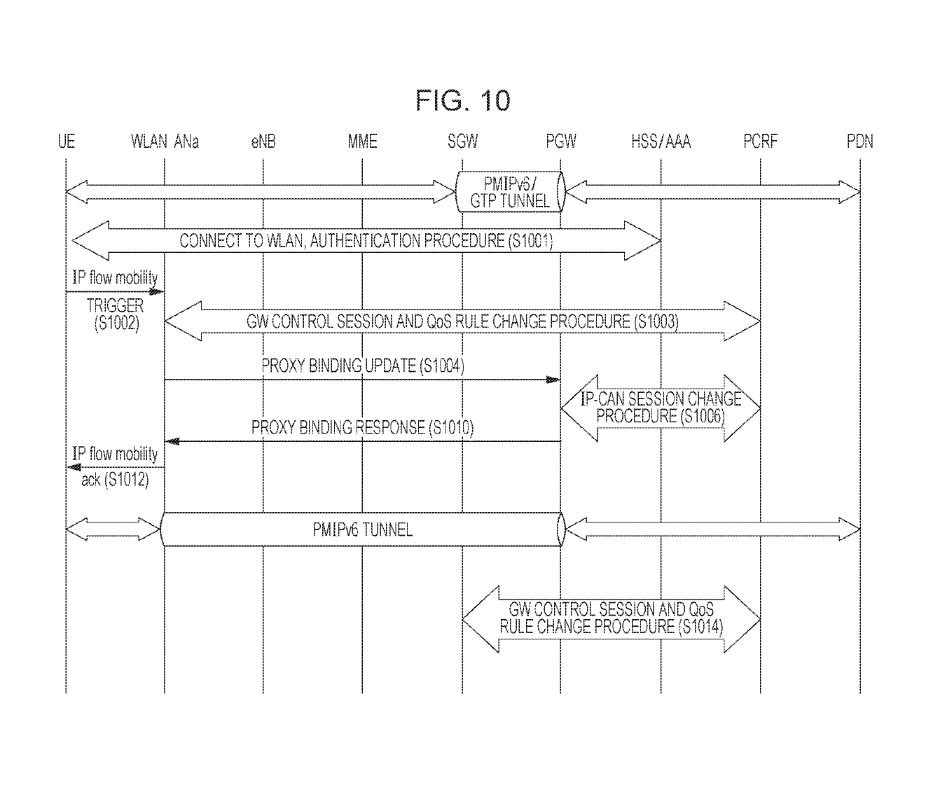

Next, a description will be given of an example in which the UE 10 switches the access system. In a case where the UE 10 determines not to switch the access system, the UE 10 does not perform a procedure of switching the access system, and continues communication of flow 1, flow 2, and flow 3 by using the communication path via LTE (via eNB 45, SGW 35, and PGW 30). Hereinafter, a description will be given of a specific procedure of switching the LTE access system by using FIG. 10.

In a case where there are a plurality of access networks of the WLAN access system that the UE 10 is connectable, the UE 10 may hold in advance a policy for selecting an access network, and may select an access network on the basis of the policy or arbitrarily. Alternatively, the mobile operator may select an access network to which the UE 10 is to be connected from among a plurality of WLAN access networks, and notify the UE 10 of information about the access network by including it in a response for access information together with the MO policy 242 (S908). Specifically, the mobile operator may select the WLAN ANa 70 and notify the UE 10. In a case where there is one access network of the WLAN access system that the UE 10 is connectable, the access network is selected.

In the following example, a description will be given of an example of a procedure of switching an access system, which is performed after the UE 10 has selected the WLAN ANa 70 as an access network by using any of the above-described methods.

First, in accordance with activation (enable) of the network interface associated with WLAN, the UE 10 selects and makes a connection to the base station provided in the WLAN ANa 70. Further, the UE 10 performs an authentication procedure for the AAA 55, and obtains permission of connection from the mobile operator (S1001).

Subsequently, the UE 10 transmits an IP flow mobility trigger to the WLAN ANa 70, and requests switching of an access system to be used for communication of a flow, so as to start switching (S1002).

The IP flow mobility trigger that is transmitted includes identification information on a flow for which switching is requested on the basis of the UE policy and identification information on the access system that is to be used after switching. Here, transmission to the WLAN ANa 70 means transmission to a device included in the WLAN ANa 70 (for example, WLAN APa 72 or GW 74).

The trigger that is transmitted includes an APN identifier. APN is information for identifying a connection destination and a connection service, and is held in advance in the UE 10. The core network 7 is able to specify a service or select the PGW 30 by using the received APN. Here, the UE 10 performs an attachment procedure by using the APN when connecting to the LTE AN 80 to establish a communication path, and transmits the same APN as the APN that is used to connect to the LTE AN 80. Accordingly, the UE 10 requests to continuously use the same IP address that is used for communication in the communication path via LTE for communication in the communication path via WLAN. Accordingly, the UE 10 requests to continue communication without changing the IP address when continuing communication by switching the access system. Since the APN identifier is the same, a connection to the PGW 30 selected by the APN at the time of connection to the LTE AN 80 can be made.

Subsequently, a GW control session and a QoS rule change procedure are performed (S1003). That is, data transmission/reception via LTE (via PGW 30, SGW 35, and eNB 45) in flow 2 from the PGW 30 is changed to data transmission/reception via the WLAN ANa 70 (PGW 30 and WLAN ANa 70). At this time, QoS in data transmission/reception via the WLAN ANa 70 (PGW 30 and WLAN ANa 70) in flow 2 is changed.

Subsequently, the WLAN ANa 70 transmits a proxy binding update to the PGW 30 and notifies the PGW 30 of a request for switching the access system to be used for communication of a flow by the UE 10 (S1004). At this time, the WLAN ANa 70 notifies the PGW 30 of, as a routing policy, switching from data transmission/reception via LTE (via PGW 30, SGW 35, and eNB 45) to data transmission/reception via WLAN (PGW 30 and WLAN ANa 70) in flow 2.

The proxy binding update that is transmitted includes identification information on the flow for which switching is requested, identification information on the access system to be used after switching, and APN. Here, transmission from the WLAN ANa 70 means transmission from a device included in the WLAN ANa 70 (for example, WLAN APa 72 or GW 74).

The PGW 30 that has received the proxy binding update starts an IP-CAN session change procedure (S1006). The PGW 30 first transmits an IP-CAN session change request to the PCRF 60. At this time, the PGW 30 provides the PCRF 60 with the updated routing rule. That is, the PGW 30 updates a database to switch data transmission/reception via LTE (via PGW 30, SGW 35, and eNB 45) in flow 2 to data transmission/reception via WLAN (PGW 30 and WLAN ANa 70).

Here, the PGW 30 associates identification information on flows with communication paths used for flows and manages them as binding. Identification information on flows includes a transmission-source IP address, a transmission-destination IP address, a transmission-source port number, a transmission-destination port number, a protocol number, and so forth of a packet. The communication paths may be managed by identifying them by access systems, or may be managed by assigning identification information to the individual communication paths via individual access systems. Accordingly, data can be transmitted/received by selecting a communication path for each flow.

Subsequently, the PGW 30 confirms update of binding, change of the IPCAN session, and completion of the GW control session and QoS rule change procedure, and transmits a proxy binding response to the WLAN ANa 70 to permit the request from the UE 10 (S1010). Further, with the APN included in the proxy binding update, the PGW 30 permits continuous use of the IP address that is used before the access system is switched.

The WLAN ANa 70 receives the proxy binding response. At this time, the communication path (PMIP tunnel) between the PGW 30 and the WLAN NAa 70 is established. Further, the WLAN ANa 70 transmits an IP flow mobility ack to permit connection of the UE 10 and continuous use of the IP address that is used before the access system is switched (S1012).

On the other hand, the PCRF 60 performs a GW control control session and a QoS rule change procedure (S1014). That is, data transmission/reception via LTE in flow 2 is finished. At this time, QoS in data transmission/reception via LTE (via PGW 30, SGW 35, and eNB 45) in flow 2 is changed.

With the above-described procedure, a communication path via the WLAN ANa 70 (PGW 30 and WLAN ANa 70) is established. The communication path is established (PMIP tunnel). In accordance with flow information, the UE 10 and the PGW 30 continues communication of flow 2 by switching the communication path from the communication path via LTE (via PGW 30, SGW 35, and eNB 45) to the communication path via the WLAN ANa 70 (PGW 30 and WLAN ANa 70).

In this way, the UE 10 is able to switch data transmission/reception via LTE (via PGW 30, SGW 35, and eNB 45) in flow 2 to data transmission/reception via WLAN (WLAN ANa 70 and PGW 30) on the basis of a request from the ANDSF 20 to the UE 10 for enabling the WLAN function and offloading a specific flow.

In other words, the MO is able to transmit, to the UE 10, a switching instruction that imposes compulsory execution on the UE 10, and cause the UE 10 to perform switching in accordance with an update of the MO policy.

In the above-described example, a description has been given of an example of simultaneously performing establishment of a communication path via WLAN and switching for a flow. Alternatively, establishment of a communication path via WLAN may be performed first, and then switching for a flow may be performed.

In this case, the UE 10 transmits an IP flow mobility trigger without including therein information on the flow for which switching is performed, and transmits a trigger for merely making a connection (S1002).

After that, a GW control session and a QoS rule change procedure are performed (S1003). The WLAN ANa 70 performs proxy binding update (S1004) for the PGW 30, an IP-CAN session change procedure (S1006), proxy binding response (S1010), and transmission of an IP flow mobility ack (S1012), and establishes a communication path via WLAN (WLAN ANa 70 and PGW 30). Identification information on a flow is not included in each procedure, and a communication path is merely established.

After that, the UE 10 transmits an IP flow mobility trigger including flow information. After that, a GW control session and a QoS rule change procedure are performed (S1003). The WLAN ANa 70 performs proxy binding update (S1004) for the PGW 30, an IP-CAN session change procedure (S1006), proxy binding response (S1010), and transmission of an IP flow mobility ack (S1012), and switches communication of flow 2 to the communication path via WLAN (WLAN ANa 70 and PGW 30) that has already been established.

Transmission/reception performed by the WLAN ANa 70 means transmission reception performed by a device included in the WLAN ANb 75 (for example, WLAN APb 76).

For flow 1 and flow 3, the UE 10 does not perform switching of a communication path by changing an access system, and continues communication by using the communication path via LTE (via PGW 30, SOW 35, and eNB 45). Accordingly, the UE 10 is able to connect to a plurality of access networks including the LTE AN 80 and the WLAN ANa 70, and perform communication via different access networks for individual flows.

### 1.3.2 Second Example

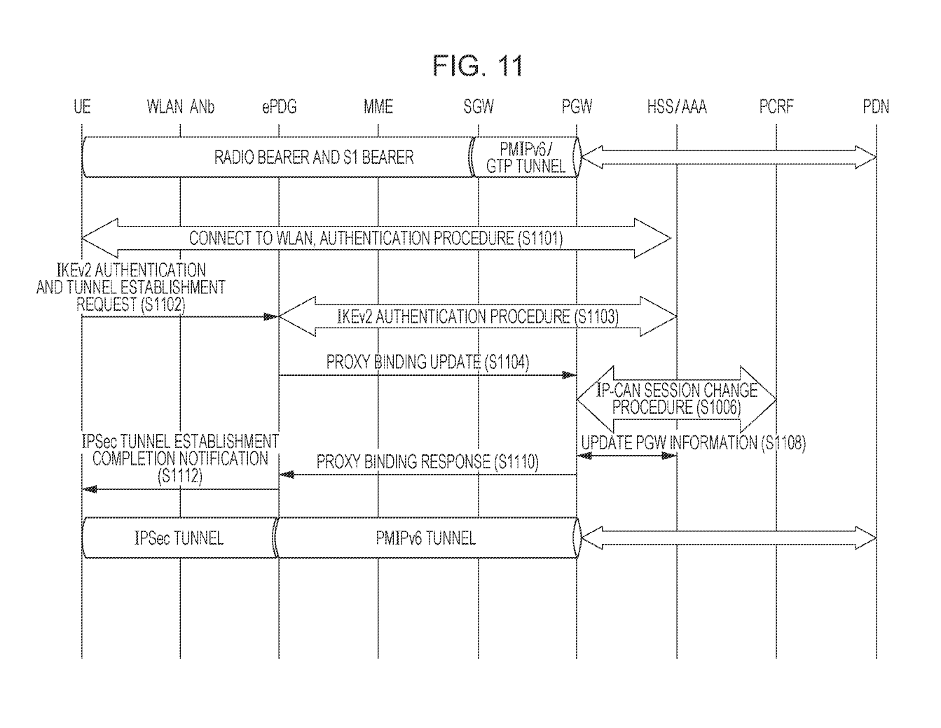

Next, a second example will be described. In the second example, in S912 in FIG. 7, the procedure illustrated in FIG. 10 is not utilized, but the procedure illustrated in FIG. 11 is utilized. The difference between the procedure illustrated in FIG. 10 and the procedure illustrated in FIG. 11 is that a connected access network is different. In the procedure illustrated in FIG. 10, a connection to the WLAN ANa 70 is made. On the other hand, in the procedure illustrated in FIG. 11, a connection to the WLAN ANb 75 is made. Selection of the WLAN ANb 75 as an access network to be connected can be performed in a similar manner to that described in the first example, and thus the description thereof is omitted.

That is, in this example, the UE 10 performs switching from the communication path via LTE (via PGW 30, SGW 35, and eNB 45) to WLAN via the WLAN ANb 75, ePDG 65, and PGW 30, not to WLAN via the WLAN ANa 70 and PGW 30.

The access system switching execution procedure (S912) described with reference to FIG. 7 is different from the first example. The procedure before that can be performed in a manner similar to that in the first example.

Referring to FIG. 11, an access system switching procedure according to this example will be described. First, in accordance with activation (enable) of the network interface associated with WLAN, the UE 10 selects and makes a connection to the base station provided in the WLAN ANa 70. Further, the UE 10 performs an authentication procedure for the AAA 55, and obtains permission of connection from the mobile operator (S1101).

Subsequently, the UE 10 transmits IKEv2 authentication and a tunnel establishment request to the ePDG 65, and requests establishment of a communication path between the UE 10 and the PGW 30 including the IPSec tunnel between the UE 10 and the ePDG 65 (S1102).

The IKEv2 authentication and the tunnel establishment request that are transmitted include identification information on the flow for which switching is requested and identification information on the access system that is to be used after switching. Further, the trigger that is transmitted includes APN, which is information for identifying the destination to be connected and a connection service. Here, the UE 10 transmits the same APN as the APN that is used for the attachment procedure performed to make a connection to the LTE AN 80. Accordingly, the UE 10 requests to continuously use the same IP address as that used for communication in the communication path via LTE in the communication path via WLAN. Accordingly, in the case of continuing communication by switching the access system, the UE 10 requests to continue communication without changing the IP address.

The ePDG 65 that has received the IKEv2 authentication and the tunnel establishment request performs an IKEv2 authentication procedure for the AAA 55 (S1103). In the authentication procedure, an authentication procedure for establishing the IPSec tunnel is performed. Further, the ePDG 65 transmits the APN included in the IKEv2 authentication and the tunnel establishment request to the AAA 55, and transmits information on the PGW 30 associated with the APN to the ePDG 65. Accordingly, the ePDG 65 is able to specify the PGW 30 for which the UE 10 has established the communication path before switching.

The ePDG 65 that has authenticated tunnel establishment through the IKEv2 authentication procedure and that has specified the PGW 30 transmits a proxy binding update to the PGW 30 and notifies the PGW 30 of a request for switching the access system to be used for communication of flow by the UE 10 (S1104). The proxy binding update that is transmitted includes identification information on the flow for which switching is requested, identification information on the access system that is to be used after switching, and APN.

The PGW 30 that has received the proxy binding update starts an IP-CAN session change procedure (S1106). The PGW 30 first transmits an IP-CAN session change request to the PCRF 60. At this time, the PGW 30 provides the PCRF 60 with the updated routing rule. That is, the PGW 30 updates a database to switch communication via LTE (via PGW 30, SGW 35, and eNB 45) in flow 2 to communication via WLAN (PGW 30, ePDG 65, and WLAN ANb 75). Here, the PGW 30 manages a flow, and performs management to transmit data to and receive data from an appropriate access system by checking a transmission-source IP address, a transmission-destination

IP address, a transmission-source port number, a transmission-destination port number, and a protocol number of a packet.

Subsequently, the PGW 30 updates PGW information for the AAA 55, and notifies the AAA 55 of information on the PGW 30 to which the UE 10 is connected (S1108). Further, the AAA 55 registers the received information in the HSS 50.

Subsequently, the PGW 30 confirms update of binding and completion of the IPCAN session change procedure, and transmits a proxy binding response to the ePDG 65 to permit the request from the UE 10 (S1110). Further, with the APN included in the proxy binding update, the PGW 30 permits continuous use of the IP address that is used before the access system is switched.

The ePDG 65 receives the proxy binding response, so that the IPSec tunnel is established between the UE 10 and the ePDG 65 in the above-described procedure. Further, the PMIP tunnel is established between the ePDG 65 and the PGW 30.

The ePDG 65 transmits an IPSec tunnel establishment completion notification (S1112) to the UE 10, and notifies the UE 10 that the communication path via WLAN (PGW 30, ePDG 65, and WLAN ANb 75) has been established and that the IPSec tunnel has been established. Further, the ePDG 65 permits continuous use of the IP address that is used before the access system is switched.

The UE 10 receives the IPSec tunnel establishment completion, recognizes that the communication path via WLAN (PGW 30, ePDG 65, and WLAN ANb 75) has been established, and continues communication of flow 2 by switching the communication path via LTE (via PGW 30, SGW 35, and eNB 45) to the communication path via the WLAN ANb 75 (PGW 30, ePDG 65, and WLAN ANb 75).

With the above-described procedure, the UE 10 and the PGW 30 continue communication of flow 2 by switching the communication path via LTE (PGW 30, SGW 35, and eNB 45) to the communication path via the WLAN ANb 75 (PGW 30, ePDG 65, and WLAN ANb 75).

Transmission/reception performed by the WLAN ANb 75 means that the UE 10 performs transmission to/reception from a device included the WLAN ANb 75 (for example, WLAN APb 76).

For flow 1 and flow 3, the UE 10 does not perform switching of a communication path by changing an access system, and continues communication by using the communication path via LTE (via PGW 30, SGW 35, and eNB 45). Accordingly, the UE 10 is able to connect to a plurality of access networks including the LTE AN 80 and the WLAN ANb 75, and perform communication via different access networks for individual flows.

### 1.3.3 Third Example

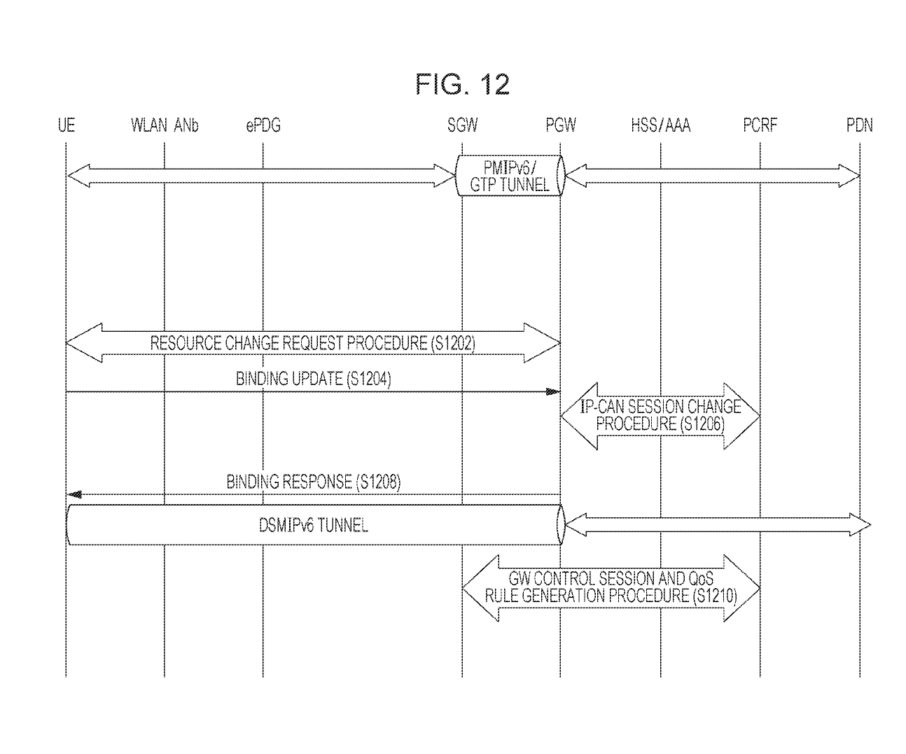

Next, a third example will be described. In the third example, in S912 in FIG. 7, the procedure illustrated in FIG. 10 and the procedure illustrated in FIG. 11 are not utilized, but the procedure illustrated in FIG. 12 is utilized.

In the procedure illustrated in FIG. 12, unlike in the procedure illustrated in FIG. 10 and the procedure illustrated in FIG. 11, a binding update is transmitted from the UE 10. In the procedure illustrated in FIG. 10 and the procedure illustrated in FIG. 11, a binding update is transmitted by the WLAN ANa 70 or the ePDG 65. In the procedure illustrated in FIG. 12, the UE 10 utilizes the function of a mobile IP, and thereby becomes able to transmit a binding update to the PGW 30.

In a case where the UE 10 is connected to access networks of a plurality of WLAN access systems as in the first and second examples, the UE 10 may hold in advance a policy for selecting an access network and may select an access network on the basis of the policy or arbitrarily. In a case where there is one access network of the WLAN access system to which the UE 10 connects, the UE 10 selects the access network. In the following example, the UE 10 selects the WLAN ANb 75 as an access network and performs an access system switching procedure.

A description will be given under the assumption that the WLAN to be connected is the WLAN ANb 75 (via WLAN ANb 75, ePDG 65, and PGW 30). However, a similar procedure is available also in the case of the WLAN ANa 70 (via WLAN ANa 70 and PGW 30).

In a specific procedure, the access system switching procedure (S912) described above with reference to FIG. 7 is different from that in the first and second examples. The procedure before that can be performed in the same manner as in the first and second examples.

With reference to FIG. 12, a description will be given of the access system switching procedure according to this example. First, in accordance with activation (enable) of the network interface associated with WLAN, the UE 10 selects and makes a connection to the base station provided in the WLAN ANa 70. Subsequently, the UE 10 performs a resource change request procedure by the UE 10 (S1202). In this procedure, before switching from LTE to the WLAN ANb 75 (via WLAN ANb 75, ePDG 65, and PGW 30), resources that are necessary for switching to the WLAN ANb 75 (via WLAN ANb 75, ePDG 65, and PGW 30) are assigned.

Subsequently, the UE 10 transmits a binding update to the PGW 30, and requests switching of the system to be used for communication of a flow (S1204). At this time, the UE 10 transmits the binding update by including therein identification information on the flow for which switching is requested, identification information on the access system to be used after switching, and APN on the basis of the UE policy.

Here, the UE 10 transmits the same APN as the APN that is used for attachment procedure performed to make a connection to the LTE AN 80. Accordingly, the UE 10 requests to continuously use the same IP address as that used for communication in the communication path via LTE in the communication path via WLAN. Accordingly, in the case of continuing communication by switching the access system, the UE 10 requests to continue communication without changing the IP address.

The PGW 30 that has received the proxy binding update starts an IP-CAN session change procedure (S1206). The PGW 30 first transmits an IP-CAN session change request to the PCRF 60. At this time, the PGW 30 provides the PCRF 60 with the updated routing rule. That is, the PGW 30 updates a database to switch communication via LTE (via PGW 30, SGW 35, and eNB 45) in flow 2 to communication via WLAN (PGW 30 and WLAN ANb 75).

Here, the PGW 30 manages identification information on flows and communication paths used for the flows in association with each other as binding. The identification on flows include a transmission-source IP address, a transmission-destination IP address, a transmission-source port number, a transmission-destination port number, a protocol number, and so forth of a packet. The communication paths may be managed by identifying them by access systems, or may be managed by assigning identification information to each communication path via each access system. Accordingly, a communication path can be selected for each flow and data can be transmitted/received.

Subsequently, the PGW 30 confirms update of binding and completion of the IP-CAN session change procedure, and transmits a binding response to the UE 10 to permit the request from the UE 10 (S1208).

Accordingly, a DSMIPv6 tunnel, which is a communication path via WLAN (WLAN b 76 and PGW 30) is established between the UE 10 and the PGW 30.

On the other hand, the PCRF 60 performs a GW control control session change and a QoS rule generation procedure (S1210). That is, communication via LTE (via PGW 30, SGW 35, and eNB 45) in flow 2 is finished. At this time, QoS in communication via LTE (via PGW 30, SGW 35, and eNB 45) in flow 2 is changed.

With the above-described procedure, in a case where the UE 10 is performing data transmission/reception via LTE or via WLAN for each flow, if the UE 10 receives the MO policy 242 (a flow (flow 2) and an access system (WLAN)) for each flow as a response for access system information from the ANDSF 20, the UE 10 reflects the MO policy 242 in the UE policy 142, and is thereby able to change data transmission/reception in the communication path via LTE (via PGW 30, SGW 35, and eNB 45) to data transmission/reception in the communication path via WLAN (WLAN b 75 and PGW 30) in flow 2.

The access network that is notified of through the MO policy 242 is not limited to the WLAN ANb 75, and may be the WLAN ANa 70 in accordance with a policy of the mobile operator. In a case where a policy of switching to the WLAN ANa 70 is received, the UE 10 is able to change data transmission/reception via LTE (via PGW 30, SGW 35, and eNB 45) to data transmission/reception via the WLAN ANa 70 (WLAN ANa and PGW 30) in flow 2 in a similar procedure. Specifically, the UE 10 transmits a binding update to the PGW 30 via the access network WLAN ANa 75, so as to change the access system.

With the above-described procedure, the UE 10 and the PGW 30 switches the communication path via LTE (via PGW 30, SGW 35, and eNB 45) to the communication path via the WLAN ANb 75 (PGW 30, ePDG 65, and WLAN ANb 75) and continues communication of flow 2.

For flow 1 and flow 3, the UE 10 does not perform switching of a communication path by changing an access system, and continues communication by using the communication path via LTE (via PGW 30, SGW 35, and eNB 45). Accordingly, the UE 10 is able to connect to a plurality of access networks including the LTE AN 80 and the WLAN ANb 75, and perform communication via different access networks for individual flows.

A description has been given under the assumption that the WLAN to be connected is the WLAN ANb 75 (via WLAN ANb 75, ePDG 65, and PGW 30). However, a similar procedure is available also in the case of the WLAN ANa 70 (via WLAN ANa 70 and PGW 30).

### 1.3.4 Fourth Example

Next, a fourth example will be described. In the first, second, and third examples, in the case of switching an access system (S912), the UE 10 transmits the same APN as the APN used for the attachment procedure performed to make a connection to the LTE AN 80, and thereby requests to continuously use the same IP address as that used for communication in the communication path via LTE in the communication path via WLAN. Accordingly, in the case of continuing communication by switching an access system, communication can be continued without changing the IP address.

Further, with the selection of the PGW 30 from the APN used for the attachment procedure performed to make a connection to the LTE AN 80, communication via the PGW 30 connected before switching can be continued.

On the other hand, in this example, a connection is made by using an APN that is different from the APN used for the attachment procedure performed to make a connection to the LTE AN 80.

Thus, in accordance with switching of an access system, communication is performed by establishing a communication path to the PDN 9 such as the Internet directly from an access network, without using the communication path via the PGW 30 that is connected before switching.

That is, in the first, second, and third examples, offload of an access network from the access network of LTE to the access network of WLAN is realized. In contrast, in this example, offload of the core network is also realized by establishing a communication path directly to the PDN 9 from an access network without via the PGW 30, in addition to offload of an access network.

In a specific procedure, the access system switching procedure (S912) described above with reference to FIG. 7 is different from that in the first example. The procedure before that can be performed in the same manner as in the first example.

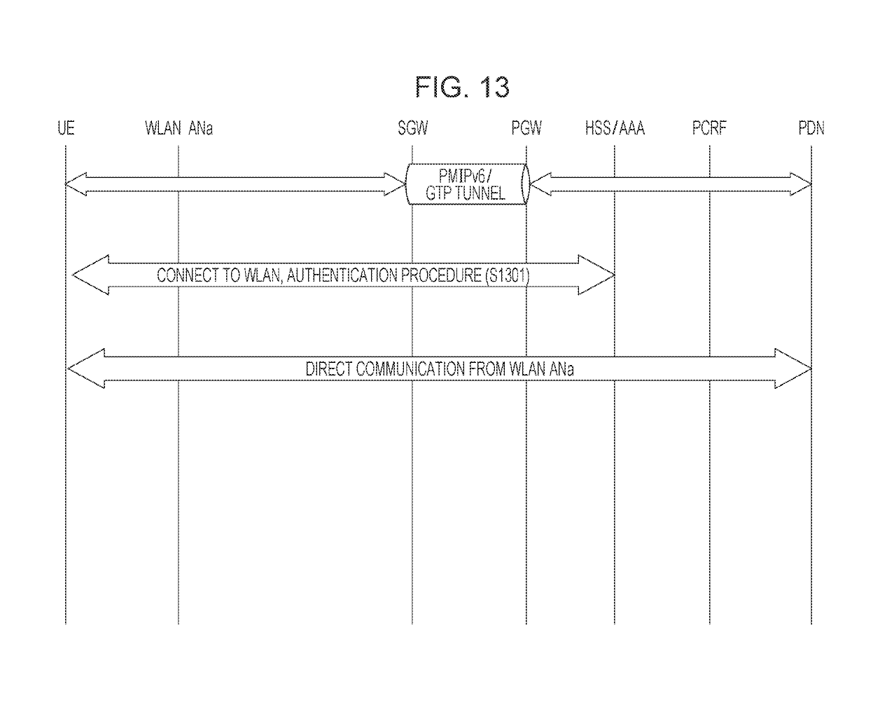

Referring to FIG. 13, a description will be given of an access system switching procedure according to this example. A description will be given under the assumption that the WLAN to be connected is the WLAN ANa 70. However, a similar procedure is available also in the case of the WLAN ANb 75.

First, in accordance with activation (enable) of the network interface associated with WLAN, the UE 10 selects and makes a connection to the base station provided in the WLAN ANa 70. Further, the UE 10 performs an authentication procedure for the AAA 55 to connect to the WLAN ANa 70 (S1301). Here, the UE 10 notifies the AAA 55 of an APN that is different from the APN used for the attachment procedure performed to connect to the LTE AN 80, and requests authentication for connection.

The APN used for connection is an APN indicating offload of the core network, in addition to offload of the access network. The UE 10 may hold in advance information on the APN.

Alternatively, information on the APN may be managed by the mobile operator, and may be assigned to a response for access system information described with reference to FIG. 7 (S908), and thereby the ANDSF 20 may notify the UE 10. In this case, since the ANDSF 20 notifies the UE 10 of the APN, the mobile operator requests the UE 10 to offload the core network in addition to offload the access network.

After the authentication procedure between the AAA 55 and the UE 10 has been completed and the connection has been permitted, the UE 10 receives an IP address from the access network when connecting to the WLAN ANa 70, and performs communication by using the IP address.

More specifically, the UE 10 switches communication of flow 2 requested through an update of the MO policy from data transmission/reception via LTE (via PGW 30, SGW 35, and eNB 45) to data transmission/reception to make a connection directly to the PDN from the WLAN ANa 70. At this time, the IP address used by the UE 10 is changed from the IP address used for data transmission/reception via LTE (via PGW 30, SGW 35, and eNB 45) to the IP address received from the access network at the time of connecting to the WLAN ANa 70, and communication is performed.

Accordingly, the UE 10 realizes offload of the core network in addition to offload of the access network.

For flow 1 and flow 3, the UE 10 does not perform switching of a communication path by changing an access system, and continues communication by using the communication path via LTE (via PGW 30, SGW 35, and eNB 45). Accordingly, the UE 10 is able to connect to a plurality of access networks including the LTE AN 80 and the WLAN ANa 70, and perform communication via different access networks for individual flows.

### 1.3.5 Modification Example

The embodiment of the present invention has been described in detail with reference to the drawings. The specific configuration is not limited to that described in the embodiment, and design and so forth within the gist of the present invention is also included in the claims.

For example, a communication path in the core network that is established through a proxy binding update and response described in the individual embodiments may be a GTP tunnel that is established on the basis of a GTP protocol. In this case, the proxy binding update and response message for establishing the communication path are replaced by a request message and response message for establishing the GTP tunnel.

The programs operated in individual devices in the individual embodiments are programs that control a CPU or the like (programs that cause a computer to function) to implement the functions of the above-described embodiment. The information that is dealt with in these devices is temporarily stored in a temporary storage device (for example, a RAM) when being processed, and is then stored in a storage device such as a ROM or HDD, and is read, modified, or written by the CPU if necessary.

Here, a recording medium for storing the programs may be any of a semiconductor medium (for example, a ROM, a nonvolatile memory card, or the like), an optical recording medium or a magneto-optical recording medium (for example, a digital versatile disc (DVD), a magneto optical (MO) disc, a MiniDisc (MD), a compact disc (CD), a BD, or the like), and a magnetic recording medium (for example, a magnetic tape, a flexible disk, or the like). The functions of the above-described embodiment are implemented by executing a loaded program. In addition, the functions of the present invention may be implemented by performing processing in cooperation with an operating system or another application program on the basis of an instruction of the program.

In the case of circulating the programs in the market, the programs may be circulated by storing them in a portable recording medium or by transferring the programs to a server computer connected via a network such as the Internet. In this case, a storage device of the server computer is of course included in the present invention.

Some or all of the devices according to the above-described embodiment may be typically implemented as a large scale integration (LSI), which is an integrated circuit. The individual functional blocks of the individual devices may be individually formed into chips, or some or all of them may be integrated into a chip. The method for integration is not limited to the LSI, and a dedicated circuit or a multi-purpose processor may be used. If the progress of the semiconductor technology produces an integration technique that replaces the LSI, an integrated circuit based on the technique can of course be used.

In the above-described embodiment, LTE and WLAN (for example, IEEE 802.11a/b/n or the like) have been described as examples of a radio access network, but a connection may be made through WiMAX instead of WLAN.

In the above-described embodiment, the ANDSF 20 has been described as an independent device that manages a policy of a mobile operator and notifies the UE 10 of an update of the policy of the mobile operator. The ANDSF 20 may be provided outside the core network 7 or inside the core network 7. Further, the ANDSF 20 may be provided as the same device as a device inside the core network 7, such as the PCRF 60 or the MME 40.

### INDUSTRIAL APPLICABILITY

The UE that has disabled a WLAN function is caused to enable the WLAN function and to switch an access system in accordance with an update of an MO policy. This technique is applicable to a mobile communication system that implements offload for appropriately alleviating concentration of traffic in LTE.

### REFERENCE SIGNS LIST

1 mobile communication system
5 IP mobile communication network
10 UE
20 ANDSF
30 PGW
35 SGW
40 MME
45 eNB
50 HSS
55 AAA
60 PCRF
65 ePDG
70 WLAN ANa
72 WLAN APa
74 GW
75 WLAN ANb
76 WLAN APb
80 LTE AN
9 PDN

1. A mobile communication system that includes a packet data network gateway (PGW), user equipment (UE), and a policy management device, the UE being configured to establish a communication path utilizing a first access system to the PGW and a communication path utilizing a second access system to the PGW, the UE including a first network interface that is configured to perform communication through the communication path utilizing the first access system and a second network interface that is different from the first network interface and that is configured to perform communication through the communication path utilizing the second access system, the UE performing communication of a plurality of flows, the policy management device notifying the UE of an update of a mobile operator policy, wherein
the UE has a UE policy in which flow identification information is associated with access system identification information so as to select an access system for each flow, and is configured to perform communication of a flow by using the communication path utilizing the first access system on the basis of the UE policy,
the policy management device includes
update circuitry for updating the mobile operator policy in which flow identification information on flows communicated by the UE is associated with access system identification information and
policy transmitting circuitry for transmitting an update of the mobile operator policy and a request for enabling a network interface to the UE, and
the UE includes
policy receiving circuitry for receiving the update of the mobile operator policy and the request for enabling the network interface,
determining circuitry for detecting that an access system information item corresponding to a flow identified by the flow identification information in the UE policy is different from an access system information item corresponding to a flow identified by the flow identification information in the update of the mobile operator policy,
communication path establishing circuitry for, in a case where the determining means determines that both the access system information items are different from each other, enabling the network interface on the basis of the request for enabling the network interface and establishing the communication path utilizing the second access system, and
communication path switching circuitry for switching communication of the flow identified by the flow identification information to the communication path utilizing the second access system.

2. User equipment (UE) in a mobile communication system that includes a packet data network gateway (PGW), the UE, and a policy management device, the UE being configured to establish a communication path utilizing a first access system to the PGW and a communication path utilizing a second access system to the PGW, the UE including a first network interface that is configured to perform communication through the communication path utilizing the first access system and a second network interface that is different from the first network interface and that is configured to perform communication through the communication path utilizing the second access system, the UE performing communication of a plurality of flows, the policy management device notifying the UE of an update of a mobile operator policy,
the UE having a UE policy in which flow identification information is associated with access system identification information so as to select an access system for each flow, the UE comprising:
communication circuitry for performing communication of a flow by using the communication path utilizing the first access system on the basis of the UE policy;
policy receiving circuitry for receiving an update of the mobile operator policy that includes flow identification information and access system identification information and a request for enabling a network interface;
determining circuitry for detecting that an access system information item corresponding to a flow identified by the flow identification information in the UE policy is different from an access system information item corresponding to a flow identified by the flow identification information in the update of the mobile operator policy;
communication path establishing circuitry for, in a case where the determining means determines that both the access system information items are different from each other, enabling the network interface on the basis of the request for enabling the network interface and establishing the communication path utilizing the second access system; and
communication path switching circuitry for switching communication of the flow identified by the flow identification information to the communication path utilizing the second access system.

3. The UE according to claim 1, wherein
the UE is configured to establish the communication path utilizing the first access system by using an APN identifier,
in a case of enabling the network interface on the basis of the request for enabling the network interface and establishing the communication path utilizing the second access system, the UE is configured to request switching of a communication path for transmitting, to the PGW, a request for switching communication of the flow identified by the flow identification information to the communication path utilizing the second access system by including the APN identifier in the request, and
the UE is configured to request to continuously use an IP address that is obtained when the communication path utilizing the first access system is established.

4. The UE according to claim 1, wherein
the UE is configured to establish the communication path utilizing the first access system by using an APN identifier,
in a case of enabling the network interface on the basis of the request for enabling the network interface and establishing the communication path utilizing the second access system, the UE is configured to make a request to switch communication of the flow identified by the flow identification information to the communication path utilizing the second access system by including an APN identifier different from the APN identifier in the request, and
the UE is configured to request to perform communication by switching an IP address to an IP address different from an IP address that is obtained when the communication path utilizing the first access system is established.

5. The UE according to claim 2, wherein
the UE is configured to receive an update of the mobile operator policy including flow identification information, access system identification information, and an APN identifier, and a request for enabling a network interface, and
the UE is configured to request to establish the communication path utilizing the second access system by using the APN identifier.
